(19) United States
(12) Patent Application Publication
(10) Pub. No.: US 2009/0197978 A1
(43) Pub. Date: Aug. 6, 2009

(54) METHODS FOR BREAKING CRUDE OIL AND WATER EMULSIONS

(76) Inventors: Nimeshkumar Kantilal Patel, Bangalore (IN); Seethalakshmi Suresh, Bangalore (IN)

Correspondence Address: General Electric Company;GE Global Patent Operation, PO Box 861, 2 Corporate Drive, Suite 648, Shelton, CT, 06484, US

(21) Appl. No.: 12/023,211

(22) Filed: Jan. 31, 2008

(51) Int. Cl. B01D 17/05

(52) U.S. Cl. 516/180; 516/191; 516/181; 516/143

(57) ABSTRACT

A method for breaking a crude oil emulsion includes treating the emulsion at an elevated temperature with a demulsifier. The demulsifier contains at least 70 percent by weight of ethylene oxide, 3-hydroxypropylene oxide, or a mixture and has a cloud point temperature of at least about 100° C. A method for desalting the crude oil is also provided.

### FIELD OF THE INVENTION

This invention relates to crude oil processing and more particularly, to methods for breaking crude oil emulsions.

### BACKGROUND OF THE INVENTION

Crude oil contains impurities that are broadly classified as salts, bottom sediment and water, solids and metals. These impurities can cause corrosion, heat exchanger fouling, furnace coking, catalyst deactivation and product degradation in the refinery and other processes, and therefore, crude oil is processed to remove these impurities.

Oil and water emulsions can occur at many stages during processing. These emulsions may occur naturally or as a by-product, such as when steam is used to transport crude oil, or may intentionally be formed, such as during a desalting process. The desalting process removes salts and other contaminants from the crude oil. Wash water is added to the crude oil and mixed intimately to contact the salts and other contaminants in the crude and transfer impurities from the crude oil to the water phase. The water and mixing form an emulsion with the crude oil, which must be resolved to separate and remove the water and the contaminants from the crude oil. The emulsion is usually resolved with the assistance of emulsion breaking chemicals, such as demulsifiers.

Emulsion breakers or demulsifiers are typically oil soluble surfactants that migrate to the interface of the emulsion allowing droplets of water (or oil) to coalesce more readily. Typical oil-based demulsifiers employed in crude oil desalting include alkoxylates of alkylphenols, alkylphenolaldehyde resins, alkylphenolaldehyde alkanolamine resins, amines, alcohols or polyetherols. However, emulsion breakers containing alkylphenol, alkylphenol ethoxylates or alkylphenol ethoxylated resins can cause environmental problems, and, in addition, they are usually formulated in an organic carrier solvent, such as a heavy aromatic naphtha that is not environmentally friendly.

It would be desirable to provide improved and environmentally-friendly methods for breaking crude oil emulsions.

### SUMMARY OF THE INVENTION

In one embodiment, a method for breaking a crude oil emulsion comprising water and crude oil, said method comprising treating the emulsion at an elevated temperature with a demulsifier, said demulsifier containing at least 70 percent by weight of units selected from the group consisting of ethylene oxide, 3-hydroxypropylene oxide, and a mixture thereof and wherein the demulsifier has a cloud point temperature of at least about 100° C.

In another embodiment, a method for desalting crude oil, said method comprising adding wash water to crude oil, forming an emulsion, treating the emulsion at an elevated temperature with a demulsifier and removing the wash water from the crude oil, wherein said demulsifier contains at least 70 percent by weight of units selected from the group consisting of ethylene oxide, 3-hydroxypropylene oxide, and a mixture thereof and said demulsifier has a cloud point temperature of at least about 100° C.

The various embodiments provide improved methods for resolving crude oil and water emulsions that are water-based and hence, more environmentally friendly.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for breaking a crude oil emulsion comprising water and crude oil, said method comprising treating the emulsion at an elevated temperature with a demulsifier, said demulsifier containing at least 70 percent by weight of units selected from the group consisting of ethylene oxide, 3-hydroxypropylene oxide, and a mixture thereof and wherein the demulsifier has a cloud point temperature of at least about 100° C.

Crude oil is any type of crude oil or petroleum and may also include liquefied coal oil, tar sand oil, oil sand oil, oil shale oil, Orinoco tar or mixtures thereof. The crude oil includes crude oil distillates, hydrocarbon oil residue obtained from crude oil distillation or mixtures thereof.

Emulsions of crude oil and water can occur at many stages in the production and processing of crude oil. An emulsion is formed when water is intimately dispersed as small droplets throughout the oil. These emulsions can be made intentionally or can occur naturally or as an indirect consequence of the crude oil processing. The crude oil and water emulsions include oil-in-water emulsions and water-in-oil emulsions.

The demulsifier is soluble in water and more environmentally friendly. It contains hydrophilic and hydrophobic moieties with at least 70 percent by weight of units selected from the group consisting of ethylene oxide, 3-hydroxypropylene oxide, and a mixture thereof and has a cloud point temperature of at least about 100° C. In one embodiment, the demulsifier is an alkoxylated polymer. In another embodiment, the demulsifier is an alkoxylated block copolymer, a polymer with pendant alkoxylated groups, a polyoxyalkylenated amine or an alkoxylated alkyl polyglycoside. In another embodiment, the polyoxyalkylenated amine may be a polyoxyalkylenated ethylene diamine, a polyoxyalkylenated diethylene triamine, a polyoxyalkylenated triethylene tetramine, a polyalkylenated tetraethylene pentamine, a polyoxyalkylenated bis(3-aminopropyl)ethylenediamine, a polyoxyalkylenated aniline, a polyoxyalkylenated p-phenylene diamine or a polyoxyalkylenated 1-naphthyl amine. In another embodiment, the alkoxylated block copolymer includes alkoxylated block copolymers with dendrimeric structures.

In one embodiment, the demulsifier is an alkoxylated polymer or alkoxylated block copolymer having the formula I:

R—O—(XO)ₐ—(YO)_{b}-(ZO)_{c}—H I

wherein R is selected from the group consisting of hydrogen, alkyl(C₁-C₃₀)phenol, dialkyl(C₂-C₃₀)phenol and a radical of a monohydric or polyhydric alcohol; X, Y and Z are each independently selected from the group consisting of methylene, ethylene, propylene, 3-hydroxypropylene, butylene, phenylene, and a mixture thereof, and a, b and c are each independently from about 1 to about 500 with the proviso that the polymer contains at least 70 percent by weight of units selected from the group consisting of ethylene oxide, 3-hydroxypropylene oxide and a mixture thereof. In one embodiment, X and Z are 3-hydroxypropylene and Y is propylene.

In one embodiment, R is hydrogen. In another embodiment, R is an alkyl(C₁-C₃₀)phenol. The alkyl(C₁-C₃₀)phenol may be linear, branched, mononuclear or polynuclear. In another embodiment, R is methylphenol, ethylphenol, propylphenol, butylphenol, isopropylphenol, pentylphenol, hexylphenol, heptylphenol, octylphenol, nonylphenol, decylphenol or dodecylphenol.

In another embodiment, R is a radical of a monohydric or polyhydric alcohol. In another embodiment, the radical is a reaction product of a C₆-C₃₀ linear or branched alcohol and an alkylene oxide. The alcohol includes, but is not limited to, hexanol, octanol and dodecanol. The alkylene oxide may be ethylene oxide, propylene oxide, butylene oxide, 3-hydroxypropylene oxide, pentylene oxide and hexylene oxide.

In one embodiment, Y is propylene. In another embodiment, X is ethylene or 3-hydroxypropylene. In another embodiment, Z is ethylene or 3-hydroxypropylene. In another embodiment, X, Y and Z are the same and are ethylene or 3-hydroxypropylene.

In one embodiment, a is from about 1 to about 500. In another embodiment, a is from about 10 to about 300. In another embodiment, a is from about 50 to about 200. In another embodiment, a is from about 75 to about 140.

In one embodiment, b is from about 1 to about 500. In another embodiment, b is from about 5 to about 300. In another embodiment, b is from about 10 to about 100. In another embodiment, b is from about 15 to about 65.

In one embodiment, c is from about 1 to about 500. In another embodiment, c is from about 10 to about 300. In another embodiment, c is from about 50 to about 200. In another embodiment, c is from about 75 to about 140.

In one embodiment, R is hydrogen, a is from about 75 to about 140, b is from about 15 to about 65 and c is from about 75 to about 140. In another embodiment, R is hydrogen, n is about 1, a is about 76, b is about 29 and c is about 76. In another embodiment, R is hydrogen, a is about 100, b is about 65 and c is about 100.

In another embodiment, the demulsifier is a polymer with pendant alkoxy groups having the formula II:

R—O—(CH₂—CH(CH₂(BO)_{d})—O)ₐ—(CH₂—CH(CH₃)—O)_{b}—(CH₂—CH(CH₂(BO)_{d})—O)_{c}—H II

wherein R is selected from the group consisting of hydrogen, alkyl(C₁-C₃₀)phenol, dialkyl(C₂-C₃₀)phenol and a radical of a monohydric or polyhydric alcohol; B is selected from the group consisting of ethylene, propylene and 3-hydroxypropylene; and a, b, c and d are each independently from about 1 to about 500.

In one embodiment, R is hydrogen. In another embodiment, R is an alkyl(C₁-C₃₀)phenol. The alkyl(C₁-C₃₀)phenol may be linear, branched, mononuclear or polynuclear. In another embodiment, R is methylphenol, ethylphenol, propylphenol, butylphenol, isopropylphenol, pentylphenol, hexylphenol, heptylphenol, octylphenol, nonylphenol, decylphenol or dodecylphenol.

In another embodiment, R is a radical of a monohydric or polyhydric alcohol. In another embodiment, the radical is a reaction product of a C₆-C₃₀ linear or branched alcohol and an alkylene oxide. The alcohol includes, but is not limited to, hexanol, octanol and dodecanol. The alkylene oxide may be ethylene oxide, propylene oxide, butylenes oxide, pentylene oxide and hexylene oxide.

In one embodiment, a is from about 1 to about 500. In another embodiment, a is from about 10 to about 300. In another embodiment, a is from about 50 to about 200. In another embodiment, a is from about 75 to about 140.

In one embodiment, b is from about 1 to about 500. In another embodiment, b is from about 5 to about 300. In another embodiment, b is from about 10 to about 100. In another embodiment, b is from about 15 to about 65.

In one embodiment, c is from about 1 to about 500. In another embodiment, c is from about 10 to about 300. In another embodiment, c is from about 50 to about 200. In another embodiment, c is from about 75 to about 140.

In one embodiment, d is from about 1 to about 500. In another embodiment, d is from about 10 to about 300. In another embodiment, d is from about 50 to about 200. In another embodiment, d is from about 75 to about 140.

In another embodiment, the demulsifier is a polymer with pendant alkoxy groups and has formula III:

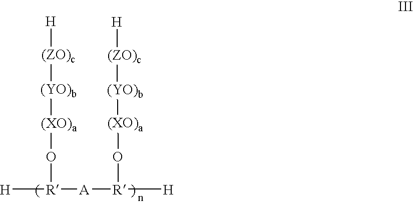

wherein R′ is an alkyl(C₁-C₃₀)phenol or dialkyl(C₂-C₃₀)phenol; X, Y and Z are each independently selected from the group consisting of methylene, ethylene, propylene, 3-hydroxypropylene, butylene, phenylene, and a mixture thereof; A is a radical of an aldehyde, an aldehyde alkanolamine or an aldehyde polyamine; a, b and c are each independently from about 1 to about 500; and n is from about 1 to about 50 with the proviso that at least 70 percent by weight of the polymer contains units selected from the group consisting of ethylene oxide, 3-hydroxypropylene oxide, and a mixture thereof.

In one embodiment, R′ is an alkyl(C₁-C₃₀)phenol. The alkyl(C₁-C₃₀)phenol may be linear, branched, mononuclear or polynuclear. In another embodiment, the alkyl group for R′ is methyl, ethyl, propyl, butyl, isopropyl, pentyl, hexyl, heptyl, octyl, nonyl, decyl or dodecyl.

A is a radical of an aldehyde, an aldehyde alkanolamine or an aldehyde polyamine. In one embodiment, the aldehyde is selected from the group consisting of formaldehyde, acetaldehyde, propanaldehyde and butyraldehyde. In another embodiment, the aldehyde alkanolamine is selected from the group consisting of formaldehyde ethanolamine, acetaldehyde ethanolamine, propanaldehyde ethanolamine and butyraldehyde ethanolamine. The alkanolamine may be monoalkanolamine, dialkanolamine or trialkanolamine. Examples of aldehyde polyamine include, but are not limited to, aldehyde ethylene diamine, aldehyde diethylene triamine, aldehyde triethylene tetramine, aldehyde tetraethylene pentamine, aldehyde bis(3-aminopropyl)ethylenediamine, aldehyde aniline, aldehyde p-phenylene diamine or aldehyde 1-naphthyl amine.

In one embodiment, n is from about 1 to about 50. In another embodiment, n is from about 1 to about 20. In another embodiment, n is about 1.

In one embodiment, Y is propylene. In another embodiment, X is ethylene or 3-hydroxypropylene. In another embodiment, Z is ethylene or 3-hydroxypropylene.

In one embodiment, a is from about 1 to about 500. In another embodiment, a is from about 10 to about 300. In another embodiment, a is from about 50 to about 200. In another embodiment, a is from about 75 to about 140.

In one embodiment, b is from about 1 to about 500. In another embodiment, b is from about 5 to about 300. In another embodiment, b is from about 10 to about 100. In another embodiment, b is from about 15 to about 65.

In one embodiment, c is from about 1 to about 500. In another embodiment, c is from about 10 to about 300. In another embodiment, c is from about 50 to about 200. In another embodiment, c is from about 75 to about 140.

In another embodiment, the demulsifier is an alkoxylated block copolymer having formula IV:

(H-(ZO)_{c}—(YO)_{b}—(XO)ₐ)₂—(R″)—((XO)ₐ—(YO)_{b}-(ZO)_{c}—H))₂ IV

wherein R″ is ethylene diamine; X, Y and Z are each independently selected from the group consisting of methylene, ethylene, propylene, 3-hydroxypropylene, butylene, phenylene, and a mixture thereof; a, b and c are each independently from about 1 to about 500; with the proviso that the polymer contains at least 70 percent by weight of units selected from the group consisting of ethylene oxide, 3-hydroxypropylene oxide, and a mixture thereof.

In one embodiment, Y is propylene. In another embodiment, X is ethylene or 3-hydroxypropylene. In another embodiment, Z is ethylene or 3-hydroxypropylene. In another embodiment, X, Y and Z are the same and are ethylene or 3-hydroxypropylene.

In one embodiment, a is from about 1 to about 500. In another embodiment, a is from about 10 to about 300. In another embodiment, a is from about 50 to about 200. In another embodiment, a is from about 75 to about 140.

In one embodiment, b is from about 1 to about 500. In another embodiment, b is from about 5 to about 300. In another embodiment, b is from about 10 to about 100. In another embodiment, b is from about 15 to about 65.

In one embodiment, c is from about 1 to about 500. In another embodiment, c is from about 10 to about 300. In another embodiment, c is from about 50 to about 200. In another embodiment, c is from about 75 to about 140.

In one embodiment, a is from about 75 to about 140, b is from about 15 to about 65 and c is from about 75 to about 140. In another embodiment, R is hydrogen, n is about 1, a is about 76, b is about 29 and c is about 76. In another embodiment, R is hydrogen, a is about 100, b is about 65 and c is about 100.

In another embodiment, the demulsifier is a polyoxyalkylenated amine having formula V:

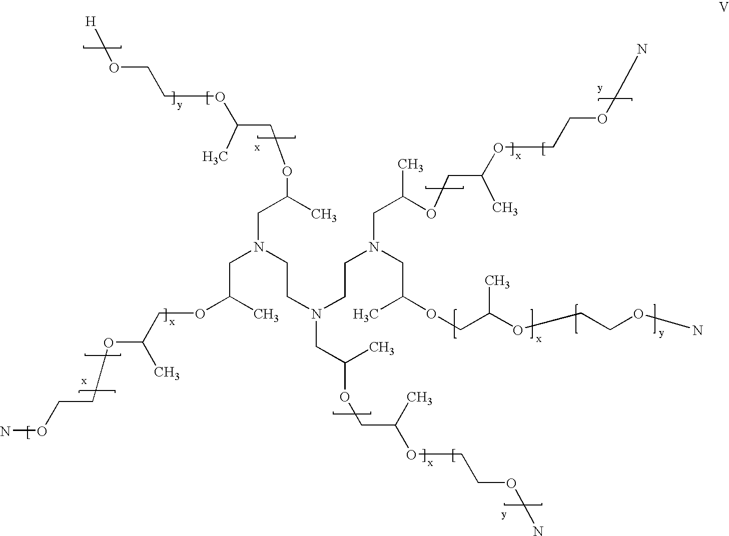

wherein x is from about 1 to about 500 and y is from about 1 to about 500.

In another embodiment, x is from about 10 to about 300. In another embodiment, x is from about 50 to about 200. In another embodiment, x is from about 75 to about 140.

In another embodiment, y is from about 5 to about 300. In another embodiment, y is from about 10 to about 100. In another embodiment, y is from about 15 to about 65.

In another embodiment, the demulsifier is an alkoxylated alkyl polyglycoside having formula VI:

R₂—O-Jₚ-O—(XO)ₐH VI

wherein R₂ is a linear or branched, saturated or unsaturated C₁₋₁₈ alkyl radical, J is an oligocosyl radical, X is selected from the group consisting of methylene, ethylene, propylene, 3-hydroxypropylene, butylene, phenylene, and a mixture thereof, a is from about 1 to about 500; and p is from about 1 to about 5 with the proviso that at least 70 percent by weight of the polymer contains units selected from the group consisting of ethylene oxide, 3-hydroxypropylene oxide, and a mixture thereof.

In one embodiment, J is pentose, hexose or mixtures thereof.

In another embodiment, the demulsifier is an alkoxylated block copolymer with a dendrimeric structure and having formula VII:

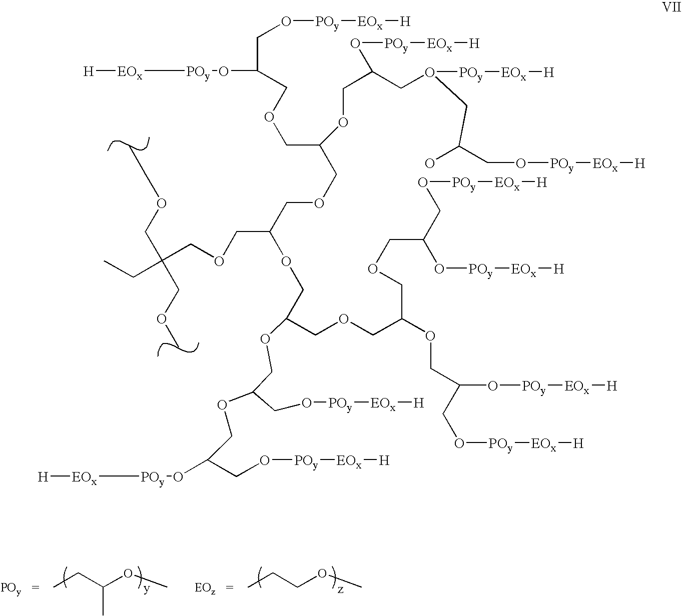

wherein y is from about 1 to about 500 and z is from about 1 to about 500.

In another embodiment, y is from about 10 to about 300. In another embodiment, y is from about 50 to about 200. In another embodiment, y is from about 75 to about 140.

In another embodiment, z is from about 5 to about 300. In another embodiment, z is from about 10 to about 100. In another embodiment, z is from about 15 to about 65.

In one embodiment, the demulsifier is an alkoxylated block copolymer having the formula VIII:

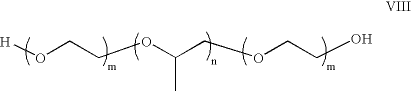

wherein m is from about 1 to about 500 and n is from about 1 to about 500 with the proviso that the ethylene oxide units are at least 70 weight percent of the polymer. In one embodiment, m is from about 75 to about 200 and n is from about 25 to about 65. In another embodiment, m is 76 and n is 29. In another embodiment, m is 100 and n is 65.

The demulsifier contains at least 70 weight percent of a hydrophilic moiety. In another embodiment, the demulsifier comprises from about 70 to about 95 weight percent of a hydrophilic moiety and from about 5 to about 30 weight percent of a hydrophobic moiety.

In one embodiment, the demulsifier has a number average molecular weight from about 500 to about 30,000 Daltons. In another embodiment, the number average molecular weight is from about 4000 to about 30,000 Daltons. In another embodiment, the number average molecular weight is from about 8000 to about 30,000 Daltons.

The demulsifier has a cloud point temperature of at least about 100° C. The cloud point temperature is the temperature at which a 1 percent by weight aqueous solution of the demulsifier turns cloudy at atmospheric pressure. The demulsifier is soluble in the aqueous phase at temperatures below the cloud point temperature and soluble in the organic phase at temperatures above the cloud point temperature. Solutions that do not turn cloudy by 100° C. are reported as having a cloud point temperature of greater than 100° C.

In alternate embodiments, the demulsifier may be modified, such as by means of esterification, urethane formation, reaction with crosslinking agents and reaction with a polymerizable monomer. In one embodiment, demulsifier may be modified with crosslinking agents, such as diacids, dianhydrides and dihalides. In one embodiment, the diacids are (C₂-C₂₀) diacids. In another embodiment, the diacids may be adipic acid or sebacic acid. In another embodiment, the dianhydrides may be tetracarboxylic acid dianhydride, 4,4′-bisphenol A dianhydride and bis(thioether) aromatic dianhydride. The dihalides may be adipoyl chloride or dodecandioyl chloride.

In another embodiment, the demulsifier is modified with diisocyanates, such as hexamethylene diisocyanate and tolylene diisocyanates. In another embodiment, the demulsifier is modified using polymerizable monomers, such as a vinyl aromatic compound, or an acrylic acid or methacrylic based monomer. In another embodiment, the demulsifier is esterified by mixing the demulsifier with a vinyl monomer in the presence of a catalyst, such as sulfuric acid or p-toluene sulfonic acid, and a stabilizer, such as a hydroquinone, which prevents polymerization. The ester product is polymerized with a polymerization catalyst, 2,2′-azobisisobutyronitrile.

The emulsion is treated by adding the demulsifier to the emulsion or to the crude oil or to the water prior to emulsification. The demulsifier can be added by any conventional means. In one embodiment, the demulsifier is added as a solution. In another embodiment, the demulsifier is added to the crude oil as a solution using a solvent that is compatible with both the demulsifier and the crude oil. In another embodiment, the demulsifier can be added to the water with a compatible solvent, such as a lower alcohol or water.

The demulsifier is added in an amount effective to aid in breaking or resolving the emulsion being treated. In one embodiment, the demulsifier can be added in amounts of from about 1 to about 1000 ppm by weight of demulsifier based on the weight of the crude oil, including from about 5 to about 50 ppm by weight of demulsifier based on the weight of the crude oil.

The demulsifier aids in breaking the emulsion and separating the water from the crude oil. The emulsions are stabilized by the presence of films formed at the interface of the oil and water, which prevents the dispersed water droplets from coalescing and separating from the oil. The demulsifier destabilizes the interfacial film and enhances coalescence of the dispersed water droplets into an aqueous phase. The aqueous or water phase settles to the bottom and can be removed from the oil phase by conventional means, such as by draining the aqueous phase from the bottom of the tank.

In one embodiment, the emulsion has an elevated temperature. In another embodiment, the temperature is from about 90° C. to about 150° C.

In another embodiment, a method for desalting crude oil, said method comprising adding wash water to crude oil, forming an emulsion, treating the emulsion at an elevated temperature with a demulsifier and removing the wash water from the crude oil, wherein said demulsifier contains at least 70 percent by weight of units selected from the group consisting of ethylene oxide, 3-hydroxypropylene oxide, and a mixture thereof and said demulsifier has a cloud point temperature of at least about 100° C.

In a desalting process, salts and other contaminants are removed from the crude oil. Wash water is added to the crude oil and mixed intimately to contact the salts and other contaminants in the crude and transfer impurities from the crude oil to the water phase. The addition and mixing of the wash water form an emulsion with the crude oil. The water and crude oil are blended in any conventional manner, such as an in-line static mixer or an in-line mix valve with a pressure drop of about 0.2 to about 2 bar depending on the density of the crude oil. In one embodiment, the water and crude oil mix are heated. In another embodiment, the temperature is from about 90° C. to about 150° C.

The water may be added in an amount of from about 4 to about 8 percent by volume of the crude oil.

The emulsion must be resolved to separate and remove the wash water containing the salts and contaminants from the crude oil. The emulsion is treated by adding the demulsifier to the emulsion or to the crude oil or to the water prior to emulsification. The demulsifier can be added by any conventional means. In one embodiment, the demulsifier is added as a solution. In another embodiment, the demulsifier is added to the crude oil as a solution using a solvent that is compatible with both the demulsifier and the crude oil. In another embodiment, the demulsifier can be added to the water with a compatible solvent, such as a lower alcohol or water.

The demulsifier is added in an amount effective to aid in breaking or resolving the emulsion being treated. In one embodiment, the demulsifier can be added in amounts of from about 1 to about 1000 ppm by weight of demulsifier based on the weight of the crude oil, including from about 5 to about 50 ppm by weight of demulsifier based on the weight of the crude oil. In one embodiment, electrodes are provided to impart an electric field through the emulsion to aid in coalescing the water droplets to facilitate resolution of the emulsion.

The demulsifier aids in breaking the emulsion and separating the water from the crude oil. The aqueous or water phase settles to the bottom and can be removed from the oil phase by conventional means, such as by draining the aqueous phase from the bottom of the tank.

In order that those skilled in the art will be better able to practice the present disclosure, the following examples are given by way of illustration and not by way of limitation.

### EXAMPLES

### Samples

CE-1 is a mixture of alkoxylated (ethylene oxide and propylene oxide (EO-PO)) alkyl phenol-formaldehyde resins and an ethylene oxide and propylene oxide block copolymer with 50 EO/50 PO.

CE-2 is a 30 EO/70 PO block copolymer.

CE-3 is a 50 EO/50 PO block copolymer.

Sample 1 is a 80 EO/20 PO block copolymer.

Sample 2 is a 70 EO/30 PO block copolymer.

### Testing

CPT is cloud point temperature. It measures the temperature at which the demulsifier begins to cloud a 1% by weight aqueous mixture solution.

MW is the number average molecular weight.

TABLE 1
Demulsifier Data

| | CPT | MW | % EO |
|---|---|---|---|
| Demulsifier | (° C.) | (Daltons) | (by wt.) |
| CE-1 | <100 | 4500 | 50 |
| CE-2 | 86 | 5000 | 30 |
| CE-3 | 91 | 6500 | 50 |
| Sample 1 | >100 | 8000 | 80 |
| Sample 2 | >100 | 13,000 | 70 |

### Example 1

A desalter electric field and desalter mix valve simulator were set up to simulate a desalter process and evaluate the effect of demulsifier samples at accelerating the breaking of water and crude oil emulsions. A demulsifier (shown in Table 1) was added to crude oil, which was mixed with wash water at a vol:vol ratio of 6:94 in a test tube. The mixing simulated a 13 psi mix valve pressure drop and an emulsion was formed. The emulsion was then allowed to settle at a temperature (as shown in Tables 2, 3 and 4 below) and at an electric field strength of 10 kV for residence times of 2, 4, 8, 16, 32 and 64 minutes. A mean water drop test was performed by taking readings of the volume of water, which had dropped to the bottom of the test tube at each of the residence times and averaging the readings. The mean water drop test indicates both the speed of water drop and the amount of water that had separated from the emulsion. Results are shown in Tables 2, 3 and 4 below.

### Example 2

A crude oil emulsion was prepared as described in Example 1. The crude oil is Petrozuata Syncrude, which has an API gravity of about 20. A dosage of about 8 ppm of each demulsifier sample shown in Table 1 was added to the crude oil before the emulsion was formed. Results are shown in Table 2.

TABLE 2

| | Mean Water Drop | Mean Water Drop | Mean Water Drop |
|---|---|---|---|
| Demulsifier | @ 132.2° C. | @ 100° C. | @ 60° C. |
| CE-1 | 3.8 | 4.1 | 5.3 |
| Sample 1 | 4.6 | 3.2 | 4.1 |
| CE-2 | 2.2 | 2.3 | 2.8 |
| CE-3 | 3.2 | 3.7 | 4.3 |

Sample 1 shows improved water drop measurements at 132.2° C. over comparative examples CE-1, CE-2 and CE-3 with good readings for the 100° C. and 60° C. temperatures.

### Example 3

A crude oil emulsion was prepared as described in Example 1. The crude oil is Russian Export Blend CZ, which has an API gravity of about 32. A dosage of about 2 ppm of each demulsifier sample (as shown in Table 1) was added to the crude oil before the emulsion was formed. Results are shown in Table 3.

TABLE 3

| | Mean Water Drop | Mean Water Drop | Mean Water Drop |
|---|---|---|---|
| Demulsifier | @ 120° C. | @ 80° C. | @ 60° C. |
| CE-1 | 3.87 | 5.70 | 5.27 |
| Sample 1 | 5.97 | 5.92 | 5.33 |
| CE-2 | 4.50 | 4.93 | 5.37 |
| CE-3 | 4.40 | 5.28 | 5.45 |

Sample 1 shows improved water drop measurements at 120° C. and at 80° C. over comparative examples CE-1, CE-2 and CE-3.

### Example 4

A crude oil emulsion was prepared as described in Example 1. The crude oil is Grane crude oil, which has an API gravity of about 20. A dosage of about 4 ppm of each demulsifier sample (as shown in Table 1) was added to the crude oil before the emulsion was formed. Results are shown in Table 4.

TABLE 4

| | Mean Water Drop | Mean Water Drop | Mean Water Drop |
|---|---|---|---|
| Demulsifier | @ 115° C. | @ 80° C. | @ 60° C. |
| CE-1 | 5.28 | 2.98 | 3.87 |
| Sample 1 | 5.45 | 2.17 | 3.02 |
| CE-2 | 4.05 | 3.15 | 3.78 |
| CE-3 | 4.33 | 3.13 | 3.58 |
| Sample 2 | 5.18 | 3.08 | 2.97 |

Samples 1 and 2 show improved water drop measurements at 115° C. over comparative examples CE-1, CE-2 and CE-3.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for breaking a crude oil emulsion comprising water and crude oil, said method comprising treating the emulsion at an elevated temperature with a demulsifier, said demulsifier containing at least 70 percent by weight of units selected from the group consisting of ethylene oxide, 3-hydroxypropylene oxide, and a mixture thereof and wherein the demulsifier has a cloud point temperature of at least about 100° C.

2. The method of claim 1 wherein the demulsifier comprises an alkoxylated polymer, an alkoxylated block copolymer, a polymer with pendant alkoxylated groups, a polyoxyalkylenated amine or alkoxylated alkyl polyglycoside.

3. The method of claim 1 wherein the demulsifier has the formula I:
R—O—(XO)ₐ—(YO)_{b}-(ZO)_{c}—H I
wherein R is selected from the group consisting of hydrogen, alkyl(C₁-C₃₀)phenol, and a radical of a monohydric or polyhydric alcohol; X, Y and Z are each independently selected from the group consisting of methylene, ethylene, propylene, 3-hydroxypropylene, butylene, phenylene, and a mixture thereof; and a, b and c are each independently from about 1 to about 500.

4. The method of claim 1 wherein the demulsifier has the formula II:
R—O—(CH₂—CH(CH₂(BO)_{d})—O)ₐ—(CH₂—CH(CH₃)—O)_{b}—(CH₂—CH(CH₂(BO)_{d})—O)_{c}—H II
wherein R is selected from the group consisting of hydrogen, alkyl(C₁-C₃₀)phenol, dialkyl(C₂-C₃₀)phenol and a radical of a monohydric or polyhydric alcohol; B and D are each independently selected from the group consisting of ethylene, propylene and 3-hydroxypropylene; and a, b, c, d and de are each independently from about 1 to about 500.

5. The method of claim 1 wherein the demulsifier has formula III: 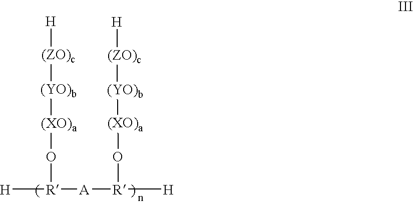
wherein R′ is an alkyl(C₁-C₃₀)phenol; X, Y and Z are each independently selected from the group consisting of methylene, ethylene, propylene, 3-hydroxypropylene, butylene, phenylene, and a mixture thereof; A is a radical of an aldehyde, an aldehyde alkanolamine or an aldehyde polyamine; a, b and c are each independently from about 1 to about 500; and n is from about 1 to about 50.

6. The method of claim 5 wherein Y is propylene.

7. The method of claim 1 wherein the demulsifier has formula IV:
(H-(ZO)_{c}—(YO)_{b}—(XO)ₐ)₂—(R″)—((XO)ₐ—(YO)_{b}-(ZO)_{c}—H))₂ IV
wherein R″ is ethylene diamine; X, Y and Z are each independently selected from the group consisting of methylene, ethylene, propylene, 3-hydroxypropylene, butylene, phenylene, and a mixture thereof; a, b and c are each independently from about 1 to about 500.

8. The method of claim 1 wherein the demulsifier is a polyoxyalkylenated amine having formula V: 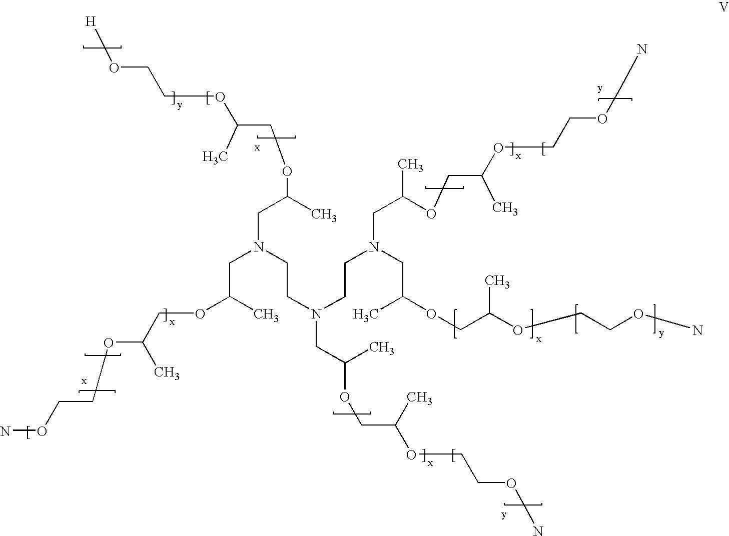
wherein x is from about 1 to about 500 and y is from about 1 to about 500.

9. The method of claim 1 wherein the demulsifier has formula VI:
R₂—O-Jₚ-O—(XO)ₐH VI
wherein R₂ is a linear or branched, saturated or unsaturated C₁₋₁₈ alkyl radical, J is an oligocosyl radical, X is selected from the group consisting of methylene, ethylene, propylene, 3-hydroxypropylene, butylene, phenylene, and a mixture thereof; p is from about 1 to about 5; and a is from about 1 to about 500.

10. The method of claim 1 wherein the demulsifier has formula VII: 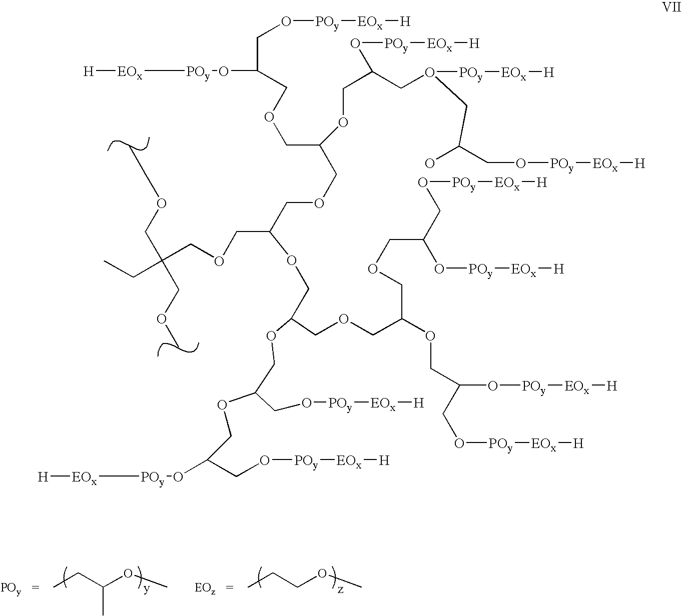
wherein y is from about 1 to about 500 and z is from about 1 to about 500.

11. The method of claim 1 wherein the demulsifier has the formula: 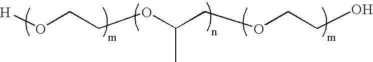
wherein m is from about 1 to about 500 and n is from about 1 to about 500.

12. The method of claim 1 wherein the demulsifier is added in an amount of from about 1 to about 1000 ppm by weight based on the weight of the crude oil.

13. The method of claim 1 wherein the emulsion has a temperature from about 90° C. to about 150° C.

14. A method for desalting crude oil, said method comprising adding wash water to crude oil, forming an emulsion, treating the emulsion at an elevated temperature with a demulsifier and removing the wash water from the crude oil, wherein said demulsifier contains at least 70 percent by weight of units selected from the group consisting of ethylene oxide, 3-hydroxypropylene oxide, and a mixture thereof and said demulsifier has a cloud point temperature of at least about 100° C.

15. The method of claim 14 wherein the demulsifier comprises an alkoxylated polymer, an alkoxylated block copolymer, a polymer with pendant alkoxylated groups, a polyoxyalkylenated amine or alkoxylated alkyl polyglycoside.

16. The method of claim 14 wherein the demulsifier has the formula I:
R—O—(XO)ₐ—(YO)_{b}-(ZO)_{c}—H I
wherein R is selected from the group consisting of hydrogen, alkyl(C₁-C₃₀)phenol, and a radical of a monohydric or polyhydric alcohol; X, Y and Z are each independently selected from the group consisting of methylene, ethylene, propylene, 3-hydroxypropylene, butylene, phenylene, and a mixture thereof; and a, b and c are each independently from about 1 to about 500.

17. The method of claim 14 wherein the demulsifier has formula II:
R—O—(CH₂—CH(CH₂(BO)_{d})—O)ₐ—(CH₂—CH(CH₃)—O)_{b}—(CH₂—CH(CH₂(BO)_{d})—O)_{c}—H II
wherein R is selected from the group consisting of hydrogen, alkyl(C₁-C₃₀)phenol, dialkyl(C₂-C₃₀)phenol and a radical of a monohydric or polyhydric alcohol; B and D are each independently selected from the group consisting of ethylene, propylene and 3-hydroxypropylene; and a, b, c, d and de are each independently from about 1 to about 500.

18. The method of claim 14 wherein the demulsifier has formula III: 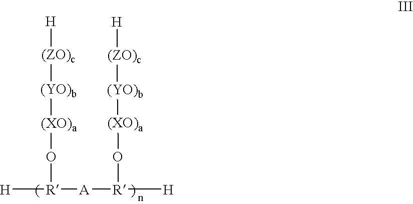
wherein R′ is an alkyl(C₁-C₃₀)phenol; X, Y and Z are each independently selected from the group consisting of methylene, ethylene, propylene, 3-hydroxypropylene, butylene, phenylene, and a mixture thereof; A is a radical of an aldehyde, an aldehyde alkanolamine or an aldehyde polyamine; a, b and c are each independently from about 1 to about 500; and n is from about 1 to about 50.

19. The method of claim 18 wherein Y is propylene.

20. The method of claim 14 wherein the demulsifier has formula IV:
(H-(ZO)_{c}—(YO)_{b}—(XO)ₐ)₂—(R″)—((XO)ₐ—(YO)_{b}-(ZO)_{c}—H))₂ IV
wherein R″ is ethylene diamine; X, Y and Z are each independently selected from the group consisting of methylene, ethylene, propylene, 3-hydroxypropylene, butylene, phenylene, and a mixture thereof; a, b and c are each independently from about 1 to about 500.

21. The method of claim 14 wherein the demulsifier has formula V: 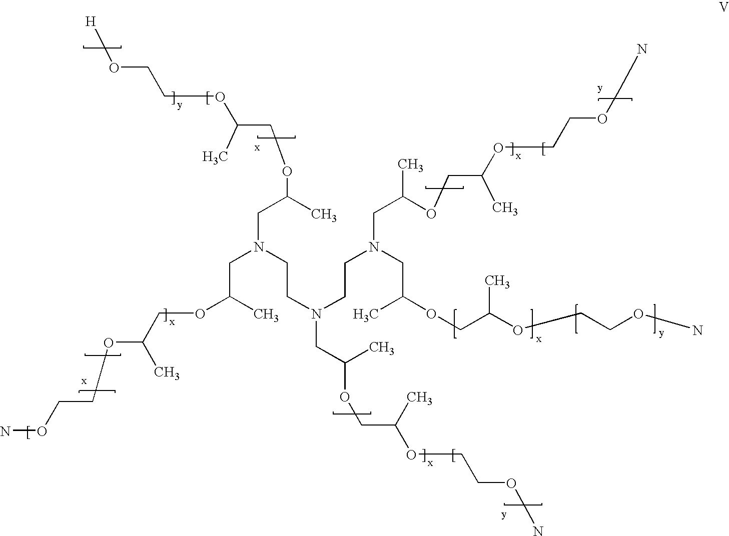
wherein x is from about 1 to about 500 and y is from about 1 to about 500.

22. The method of claim 14 wherein the demulsifier has formula VI:
R₂—O-Jₚ-O—(XO)ₐH VI
wherein R₂ is a linear or branched, saturated or unsaturated C₁₋₁₈ alkyl radical, J is an oligocosyl radical, X is selected from the group consisting of methylene, ethylene, propylene, 3-hydroxypropylene, butylene, phenylene, and a mixture thereof; a is from about 1 to about 500; and p is from about 1 to about 5.

23. The method of claim 14 wherein the demulsifier has formula VII: 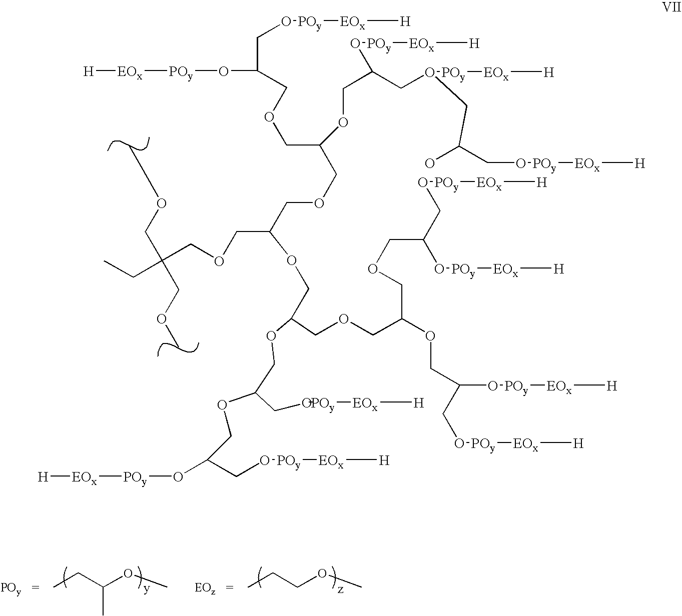
wherein x is from about 1 to about 500 and y is from about 1 to about 500.

24. The method of claim 14 wherein the demulsifier has the formula: 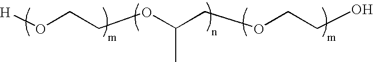
wherein m is from about 1 to about 500 and n is from about 1 to about 500.

25. The method of claim 14 wherein the demulsifier is added in an amount of from about 1 to about 1000 ppm by weight based on the weight of the crude oil.

26. The method of claim 14 wherein the emulsion has a temperature from about 90° C. to about 150° C.
